(19) United States
(12) Patent Application Publication
(10) Pub. No.: US 2025/0105974 A1
(43) Pub. Date: Mar. 27, 2025

(54) REFERENCE SIGNAL TIME DIFFERENCE (RSTD) MEASUREMENT AND REPORTING FOR NTN POSITIONING

(71) Applicant: QUALCOMM Incorporated, San Diego, CA (US)

(72) Inventors: Chiranjib SAHA, Lakeside, CA (US); Harikumar KRISHNAMURTHY, San Diego, CA (US); Alberto RICO ALVARINO, San Diego, CA (US); Alexandros MANOLAKOS, Athens, Attikí (GR); Xiao Feng WANG, San Diego, CA (US); Ayan SENGUPTA, San Diego, CA (US)

(21) Appl. No.: 18/728,957

(22) PCT Filed: Feb. 21, 2023
(86) PCT No.: PCT/US2023/062950

§ 371 Date: Jul. 15, 2024

(30) Foreign Application Priority Data
Mar. 8, 2022 (GR) 20220100218

(51) Int. Cl. H04L 5/00; G01S 5/00; G01S 5/02; G01S 5/10; H04W 64/00

(52) U.S. Cl. CPC H04L 5/0051; G01S 5/0036; G01S 5/0236; G01S 5/0244; G01S 5/10; H04W 64/00

(57) ABSTRACT

In some implementations, a location server may, in a positioning session between the location server and a user equipment (UE): receive, from the UE, a report message comprising reference signal time difference (RSTD) measurement information of an RSTD measurement, performed by the UE, of radio frequency (RF) signals, wherein: at least one RF signal of the RF signals is transmitted by an NTN Next Generation Radio Access Network (NG-RAN) node, and the RSTD measurement information comprises an offset to compensate for a delay in the at least one RF signal. The location server may determine a position of the UE based at least in part on the RSTD measurement information.

### RELATED APPLICATIONS

This application claims the benefit of Greek Application No. 20220100218, filed Mar. 8, 2022, entitled “RSTD Measurement and Reporting for NTN Positioning”, which is assigned to the assignee hereof, and incorporated herein in its entirety by reference.

### BACKGROUND

### 1. Field of Disclosure

The present disclosure relates generally to the field of radiofrequency (RF)-based position determination (or positioning) of an electronic wireless device. More specifically, the present disclosure relates to Non-Terrestrial Network (NTN)-based positioning.

### 2. Description of Related Art

The positioning of devices can have a wide range of consumer, industrial, commercial, military, and other applications. Positioning of a mobile device such as a user equipment (UE) in a wireless communication network (e.g., a wireless cellular network) may be accomplished using measurements of RF signals sent and/or received between the UE and one or more transceivers of the wireless communication network. A location server may be used to coordinate the transmission and measurement of these RF signals. As wireless communication networks expand to include NTN transceivers (e.g., satellites), the wireless communication networks can offer coverage for positioning applications in addition or as an alternative to Terrestrial Network (TN)-based positioning. However, current techniques for providing assistance data and reporting reference signal time difference (RSTD) measurements are incapable of accommodating factors that need to be taken into account when performing positioning of the mobile device using NTN positioning.

### BRIEF SUMMARY

In some implementations, a location server may, in a positioning session between the location server and a user equipment (UE): receive, from the UE, a report message comprising RSTD measurement information of an RSTD measurement, performed by the UE, of radio frequency (RF) signals, wherein: at least one RF signal of the RF signals is transmitted by an NTN Next Generation Radio Access Network (NG-RAN) node, and the RSTD measurement information comprises an offset to compensate for a delay in the at least one RF signal. The location server may determine a position of the UE based at least in part on the RSTD measurement information.

An example method of utilizing modified Reference Signal Time Difference (RSTD) reporting for Non-Terrestrial Network (NTN) positioning, according to this disclosure, may comprise, in a positioning session between a location server and a user equipment (UE), receiving, at the location server from the UE, a report message comprising RSTD measurement information of an RSTD measurement, performed by the UE, of radio frequency (RF) signals, wherein: at least one RF signal of the RF signals is transmitted by an NTN Next Generation Radio Access Network (NG-RAN) node, and the RSTD measurement information comprises an offset of at least one subframe duration to compensate for a delay in the at least one RF signal, and determining, at the location server, a position of the UE based at least in part on the RSTD measurement information.

An example method of utilizing modified Reference Signal Time Difference (RSTD) reporting for Non-Terrestrial Network (NTN) positioning, according to this disclosure, may comprise in a positioning session between a location server and a user equipment (UE), performing an RSTD measurement, with the UE, of radio frequency (RF) signals, wherein at least one RF signal of the RF signals is transmitted by an NTN Next Generation Radio Access Network (NG-RAN) node; and sending, to the location server from the UE, a report message comprising RSTD measurement information of the RSTD measurement, wherein the RSTD measurement information comprises an offset of at least one subframe duration to compensate for a delay in the at least one RF signal.

An example location server for utilizing modified Reference Signal Time Difference (RSTD) reporting for Non-Terrestrial Network (NTN) positioning, according to this disclosure, may comprise a transceiver, a memory, one or more processors communicatively coupled with the transceiver and the memory, wherein the one or more processors are configured to, in a positioning session between the location server and a user equipment (UE): receive, via the transceiver from the UE, a report message comprising RSTD measurement information of an RSTD measurement, performed by the UE, of radio frequency (RF) signals, wherein: at least one RF signal of the RF signals is transmitted by an NTN Next Generation Radio Access Network (NG-RAN) node, and the RSTD measurement information comprises an offset of at least one subframe duration to compensate for a delay in the at least one RF signal; and determine a position of the UE based at least in part on the RSTD measurement information.

An example user equipment (UE) for utilizing modified Reference Signal Time Difference (RSTD) reporting for Non-Terrestrial Network (NTN) positioning, according to this disclosure, may comprise a transceiver, a memory, one or more processors communicatively coupled with the transceiver and the memory, wherein the one or more processors are configured to, in a positioning session between a location server and the UE: perform an RSTD measurement of radio frequency (RF) signals, wherein at least one RF signal of the RF signals is transmitted by an NTN Next Generation Radio Access Network (NG-RAN) node; and send, via the transceiver to the location server, a report message comprising RSTD measurement information of the RSTD measurement, wherein the RSTD measurement information comprises an offset of at least one subframe duration to compensate for a delay in the at least one RF signal.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

The appended drawings are provided to complement the following description. It can be noted that, the term “background” is included in the text of many of the appended drawings to provide context for the embodiments described herein. It does not necessarily follow, however, that such information should be considered prior art. Some information identified as background in the appended drawings may, in fact, comprise novel features used by one or more embodiments described herein.

FIG. 1 is a diagram of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication network.

FIG. 3 is a timing diagram of transmissions by two different transmitters, illustrating a subframe offset at the network, which may be accounted for when performing positioning, according to some embodiments.

FIG. 4 is a timing diagram of transmissions by two different transmitters illustrating an expected RSTD and a positioning reference signal (PRS) search window, according to an embodiment.

FIG. 5 is a graph depicting an NTN positioning scenario, according to an embodiment.

FIG. 6 is a message flow diagram illustrating a process of how assistance data may be delivered in a positioning system using LPP, according to some embodiments.

FIGS. 7A and 7B are timing diagrams illustrating how RSTD for NTN positioning may be defined, according to some embodiments.

FIG. 7C is a diagram illustrating how an additional bit allocation and expected RSTD uncertainty may be determined, according to some embodiments.

FIG. 8 is a flow diagram of a method utilizing modified RSTD reporting for NTN positioning, according to an embodiment.

FIG. 9 is a flow diagram of another method of utilizing modified RSTD reporting for NTN positioning, according to an embodiment.

FIG. 10 is a block diagram of an embodiment of a UE, which can be utilized in embodiments as described herein.

FIG. 11 is a block diagram of an embodiment of an NTN Next Generation Radio Access Network (NG-RAN) node, which can be utilized in embodiments as described herein.

FIG. 12 is a block diagram of an embodiment of a computer system, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may be referred to as reference signals (RS) and may comprise any of a variety of signal types but may not necessarily be limited to a Positioning Reference Signal (PRS) as defined in relevant wireless standards.

Further, unless otherwise specified, the term “positioning,” “position determination,” “location determination,” “location estimation,” and the like, as used herein may include absolute location determination, relative location determination, ranging, or a combination thereof. Such positioning may include and/or be based on timing, angular, phase, or power measurements, or a combination thereof (which may include RF sensing measurements) for the purpose of location or sensing services.

As noted, wireless communication networks are expanding to include Non-Terrestrial Network (NTN) nodes (e.g., satellites and/or base stations in communication with NTN satellites), which can enable the wireless communication networks to offer coverage for positioning applications in addition or as an alternative to Terrestrial Network (TN)-based positioning. Currently, however, information shared by an NTN transceiver/node with location server and assistance data provided from the location server to a UE may not include NTN-specific information, which can prevent the determination of an accurate location of the UE. To address these and other issues, embodiments provide for in modified assistance data and reporting with respect to reference signal time difference (RSTD) measurements, to accommodate for additional signal delay in an NTN positioning scenario. Advantages/benefits provided by the embodiments may include, for example, enabling RSTD measurements for NTN positioning, allowing for positioning in NTN scenarios that may not be allowed for using traditional assistance data and reporting. A detailed description of the embodiments is provided hereafter, following a review of the relevant technologies.

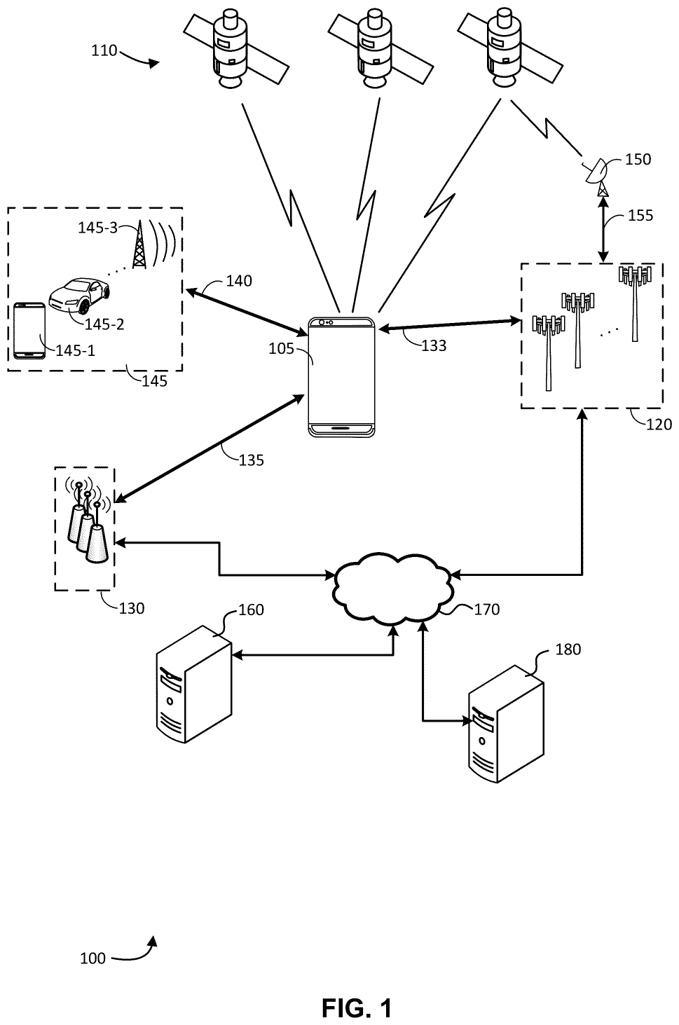

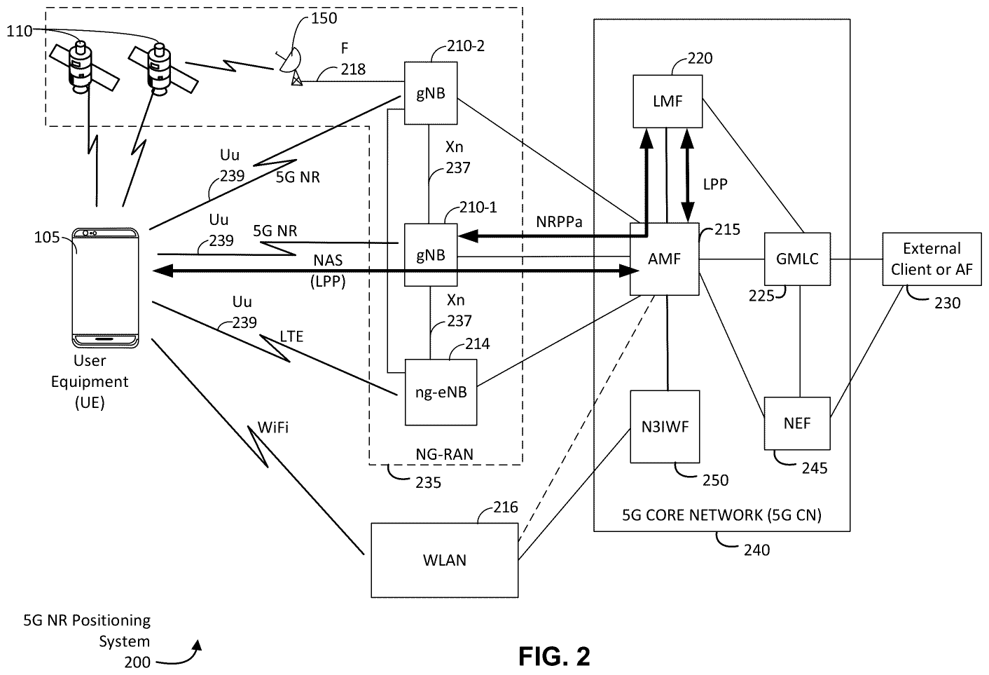

FIG. 1 is a simplified illustration of a positioning system 100 in which a UE 105, location server 160, and/or other components of the positioning system 100 can use the techniques provided herein for determining an estimated location of UE 105, according to an embodiment. The techniques described herein may be implemented by one or more components of the positioning system 100. The positioning system 100 can include: a UE 105; one or more satellites 110 (also referred to as space vehicles (SVs)) for a Global Navigation Satellite System (GNSS) (such as the Global Positioning System (GPS), GLONASS, Galileo or Beidou) and/or NTN functionality; base stations 120; access points (APs) 130; location server 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As noted, satellites 110 may be used to implement NTN functionality, extending communication, positioning, and potentially other functionality (e.g., RF sensing) of a terrestrial network. As such, one or more satellites may be communicatively linked to one or more NTN gateways 150 (also known as “gateways,” “earth stations,” or “ground stations”). The NTN gateways 150 may be communicatively linked with base stations 120 via link 155. In some embodiments, NTN gateways 150 may function as DUs of a base station 120, as described previously. Not only can this enable the UE 105 to communicate with the network 170 via satellites 110, but this can also enable network-based positioning, RF sensing, etc.

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the UE 105, or a combination thereof. Wireless signals from mobile devices 145 used for positioning of the UE 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the UE 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular UE 105, the UE 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and UE 105 may comprise sidelink and/or similar Device-to-Device (D2D) communication technologies. Sidelink, which is defined by 3GPP, is a form of D2D communication under the cellular-based LTE and NR standards.

According to some embodiments, such as when the UE 105 comprises and/or is incorporated into a vehicle, a form of D2D communication used by the UE 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The UE 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the UE 105 and may be used to determine the position of the UE 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the UE 105, according to some embodiments.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

As previously noted, the example positioning system 100 can be implemented using a wireless communication network, such as an LTE-based or 5G NR-based network. FIG. 2 shows a diagram of a 5G NR positioning system 200, illustrating an embodiment of a positioning system (e.g., positioning system 100) implementing 5G NR. The 5G NR positioning system 200 may be configured to determine the location of a UE 105 by using access nodes, which may include NR NodeB (gNB) 210-1 and 210-2 (collectively and generically referred to herein as gNBs 210), ng-eNB 214, and/or WLAN 216 to implement one or more positioning methods. The gNBs 210 and/or the ng-eNB 214 may correspond with base stations 120 of FIG. 1, and the WLAN 216 may correspond with one or more access points 130 of FIG. 1. Optionally, the 5G NR positioning system 200 additionally may be configured to determine the location of a UE 105 by using an LMF 220 (which may correspond with location server 160) to implement the one or more positioning methods. Here, the 5G NR positioning system 200 comprises a UE 105, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. Additional components of the 5G NR positioning system 200 are described below. The 5G NR positioning system 200 may include additional or alternative components.

The 5G NR positioning system 200 may further utilize information from satellites 110. As previously indicated, satellites 110 may comprise GNSS satellites from a GNSS system like Global Positioning System (GPS) or similar system (e.g. GLONASS, Galileo, Beidou, Indian Regional Navigational Satellite System (IRNSS)). Additionally or alternatively, satellites 110 may comprise NTN satellites. NTN satellites may be in low earth orbit (LEO), medium earth orbit (MEO), geostationary earth orbit (GEO) or some other type of orbit. NTN satellites may be communicatively coupled with the LMF 220 and may operatively function as a TRP (or TP) in the NG-RAN 235. As such, satellites 110 may be in communication with one or more gNBs 210 via one or more NTN gateways 150. According to some embodiments, an NTN gateway 150 may operate as a DU of a gNB 210, in which case communications between NTN gateway 150 and CU of the gNB 210 may occur over an F interface 218 between DU and CU.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR positioning system 200. Similarly, the 5G NR positioning system 200 may include a larger (or smaller) number of satellites 110, gNBs 210, ng-eNBs 214, Wireless Local Area Networks (WLANs) 216, Access and mobility Management Functions (AMF)s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 105 may also support wireless communication using a WLAN 216 which (like the one or more RATs, and as previously noted with respect to FIG. 1) may connect to other networks, such as the Internet. The use of one or more of these RATs may allow the UE 105 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 105 (e.g., via the GMLC 225). The external client 230 of FIG. 2 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 105 via wireless communication between the UE 105 and one or more of the gNBs 210, which may provide wireless communications access to the 5G CN 240 on behalf of the UE 105 using 5G NR. The wireless interface between base stations (gNBs 210 and/or ng-eNB 214) and the UE 105 may be referred to as a Uu interface 239. 5G NR radio access may also be referred to as NR radio access or as 5G radio access. In FIG. 2, the serving gNB for UE 105 is assumed to be gNB 210-1, although other gNBs (e.g. gNB 210-2) may act as a serving gNB if UE 105 moves to another location or may act as a secondary gNB to provide additional throughput and bandwidth to UE 105.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 105. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 105 but may not receive signals from UE 105 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 105. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 105 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 105 to other elements in 5G CN 240 and/or may support interworking of one or more protocols used by WLAN 216 and UE 105 to one or more protocols used by other elements of 5G CN 240 such as AMF 215. For example, N3IWF 250 may support IPSec tunnel establishment with UE 105, termination of IKEv2/IPSec protocols with UE 105, termination of N2 and N3 interfaces to 5G CN 240 for control plane and user plane, respectively, relaying of uplink (UL) and downlink (DL) control plane Non-Access Stratum (NAS) signaling between UE 105 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 105 and the AMF 215. As noted, this can include gNBs 210, ng-eNB 214, WLAN 216, and/or other types of cellular base stations, and may also include NTN satellites 110. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214, WLAN 216, or NTN satellite 110.

In some embodiments, an access node, such as a gNB 210, ng-eNB 214, WLAN 216, or NTN satellite 110, or a combination thereof, (alone or in combination with other components of the 5G NR positioning system 200), may be configured to, in response to receiving a request for location information from the LMF 220, obtain location measurements of uplink (UL) signals received from the UE 105) and/or obtain downlink (DL) location measurements from the UE 105 that were obtained by UE 105 for DL signals received by UE 105 from one or more access nodes. As noted, while FIG. 2 depicts access nodes (gNB 210, ng-eNB 214, WLAN 216, and NTN satellite 110) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 105 may be applicable to such other networks.

The gNBs 210 and ng-eNB 214 can communicate with an AMF 215, which, for positioning functionality, communicates with an LMF 220. The AMF 215 may support mobility of the UE 105, including cell change and handover of UE 105 from an access node (e.g., gNB 210, ng-eNB 214, WLAN 216, or NTN satellite 110) of a first RAT to an access node of a second RAT. The AMF 215 may also participate in supporting a signaling connection to the UE 105 and possibly data and voice bearers for the UE 105. The LMF 220 may support positioning of the UE 105 using a CP location solution when UE 105 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 105, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such gNB 210, ng-eNB 214, WLAN 216, or NTN satellite 110, and/or using assistance data provided to the UE 105, e.g., by LMF 220).

The Gateway Mobile Location Center (GMLC) 225 may support a location request for the UE 105 received from an external client 230 and may forward such a location request to the AMF 215 for forwarding by the AMF 215 to the LMF 220. A location response from the LMF 220 (e.g., containing a location estimate for the UE 105) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 105 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 105 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 105 may communicate using an LTE Positioning Protocol (LPP) as defined in 3GPP TS 37.355. Here, LPP messages may be transferred between the UE 105 and the LMF 220 via the AMF 215 and a serving gNB 210-1 or serving ng-eNB 214 for UE 105. For example, LPP messages may be transferred between the LMF 220 and the AMF 215 using messages for service-based operations (e.g., based on the Hypertext Transfer Protocol (HTTP)) and may be transferred between the AMF 215 and the UE 105 using a 5G NAS protocol. The LPP protocol may be used to support positioning of UE 105 using UE assisted and/or UE based position methods such as A-GNSS, RTK, TDOA, multi-cell RTT, AoD, and/or ECID. The NRPPa protocol may be used to support positioning of UE 105 using network based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 105 access to WLAN 216, LMF 220 may use NRPPa and/or LPP to obtain a location of UE 105 in a similar manner to that just described for UE 105 access to a gNB 210 or ng-eNB 214. Thus, NRPPa messages may be transferred between a WLAN 216 and the LMF 220, via the AMF 215 and N3IWF 250 to support network-based positioning of UE 105 and/or transfer of other location information from WLAN 216 to LMF 220. Alternatively, NRPPa messages may be transferred between N3IWF 250 and the LMF 220, via the AMF 215, to support network-based positioning of UE 105 based on location related information and/or location measurements known to or accessible to N3IWF 250 and transferred from N3IWF 250 to LMF 220 using NRPPa. Similarly, LPP and/or LPP messages may be transferred between the UE 105 and the LMF 220 via the AMF 215, N3IWF 250, and serving WLAN 216 for UE 105 to support UE assisted or UE based positioning of UE 105 by LMF 220.

In a 5G NR positioning system 200, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or “network-based”).

With a UE-assisted position method, UE 105 may obtain location measurements and send the measurements to a location server (e.g., LMF 220) for computation of a location estimate for UE 105. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), RSTD, Time of Arrival (TOA), AoA, Receive Time-Transmission Time Difference (Rx-Tx), Differential AoA (DAoA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for GNSS satellites), WLAN, etc.

With a UE-based position method, UE 105 may obtain location measurements (e.g., which may be the same as or similar to location measurements for a UE assisted position method) and may further compute a location of UE 105 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 105, and/or may receive measurements obtained by UE 105 or by an AP in WLAN 216 in the case of N3IWF 250, and may send the measurements to a location server (e.g., LMF 220) for computation of a location estimate for UE 105.

Positioning of the UE 105 also may be categorized as UL, DL, or DL-UL based, depending on the types of signals used for positioning. If, for example, positioning is based solely on signals received at the UE 105 (e.g., from a base station or other UE), the positioning may be categorized as DL based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, that is based on signals that are both transmitted and received by the UE 105. Sidelink (SL)-assisted positioning comprises signals communicated between the UE 105 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

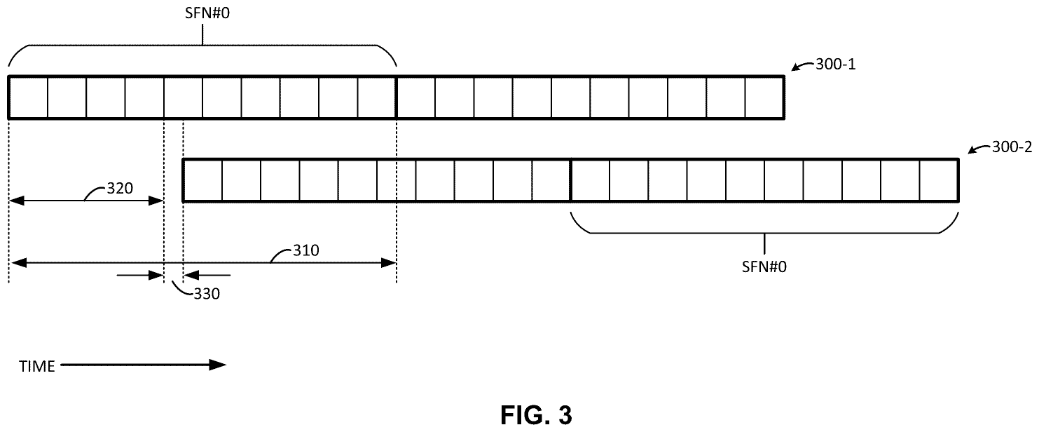

As previously noted, RSTD measurements may be used for positioning of a UE. In the relevant 3GPP standard (TS 38.215) DL RSTD is defined as the DL relative timing difference between the Transmission Point (TP) j and the reference TP i, defined as T_{SubframeRx,j}−T_{SubframeRx,i} where T_{SubframeRx,j} is the time when the UE receives the start of one subframe from TP j, and T_{SubframeRx,i} is the time when the UE receives the corresponding start of one subframe from TP i that is closest in time to the subframe received from TP j. Multiple DL PRS resources can be used to determine the start of one subframe from a TP. For frequency range 1 (FR1), the reference point for the DL RSTD is the antenna connector of the UE. For frequency range 2 (FR2), the reference point for the DL RSTD is the antenna of the UE. In some instances, the TP i that is closest in time to the subframe received from TP j may occur prior to the subframe received from TP j. Thus, the full reporting range of the RSTD measurement is [−0.5 ms, 0.5 ms]. Because static subframes are 1 ms in length, this reporting range is sufficient to capture all relative time differences between the beginning of a subframe of the reference TP and the beginning of a closest subframe of another TP, if TPs are static. Transmitted subframes may not necessarily be synchronized, however, as illustrated in FIG. 3.

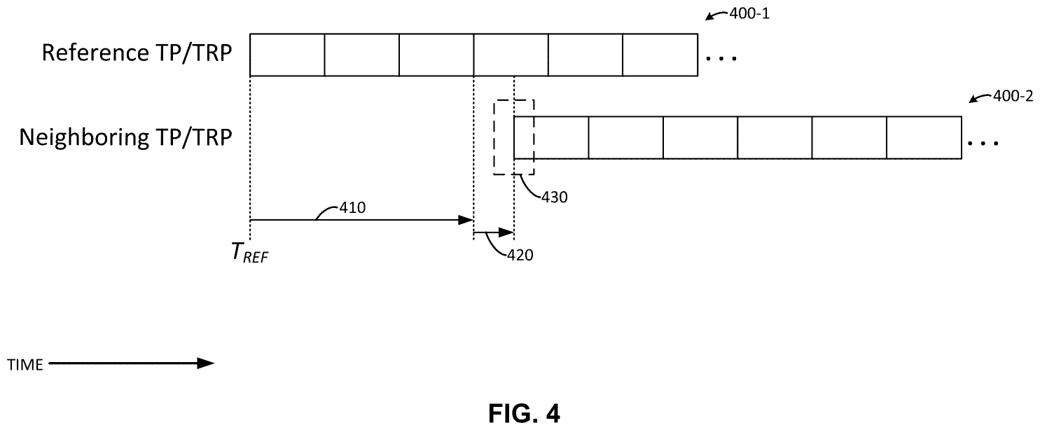

FIG. 3 is a timing diagram of transmissions 300 by two different TPs (or TRPs), illustrating a subframe offset at the network, which may need to be accounted for when performing positioning. For example, for TDoA measurements, there may be some time offset between transmitting TPs (or TRPs), rather than subframes being perfectly synchronized. Accordingly, the network (e.g., cellular/mobile broadband network) can indicate the offset between TPs/TRPs to a UE (e.g., via LPP communications from a location server) using a field called nr-DL-PRS-SFN0-Offset (as defined in TS 37.355). In the nr-DL-PRS-SFN0-Offset field, the time offset of the SFN #0 slot #0 for a given TP/TRP with respect to SFN #0 slot #0 of an assistance data reference TP/TRP and comprises the subfields “Sfn-Offset” and “integerSubframeOffset.” The Sfn-Offset corresponds to the number of full radio frames counted from the beginning of a radio frame #0 of the assistance data reference TP/TRP to the beginning of the closest subsequent radio frame #0 of this neighbor TP/TRP. The integerSubframeOffset offset is counted from the beginning of a subframe #0 of the assistance data reference TP/TRP to the beginning of the closest subsequent subframe #0 of this neighbor TP/TRP, rounded down to multiples of subframes. In FIG. 3, an offset between a first transmission 300-1 of an assistance data reference TP/TRP and a second transmission 300-2 of a neighbor TP/TRP may be described as having Sfn-Offset=1 (shown by arrow 310) and integerSubframeOffset=4 (shown by arrow 320). As described in more detail with regard to FIG. 4, remaining offset (arrow 330) may be accounted for using an expected RSTD.

FIG. 4 is a timing diagram of transmissions 400 by two different TPs (or TRPs) illustrating an expected RSTD and a positioning reference signal (PRS) search window. Here, an offset between a first transmission 400-1 of an assistance data reference TP/TRP and a second transmission 400-2 of a neighbor TP/TRP has and offset that can be described as the sum of a primary offset 410 of N ms (e.g., N subframes) and a residual offset 420. The PRS search window 430 may comprise a window of time in which a PRS signal is expected at a target device, enabling the target device to focus a search for the PRS signal (rather than searching blindly for a PRS signal, which could consume relatively large amounts of power).

A target device (e.g., a target UE) may assume that the beginning of the subframe for the PRS of a TP/TRP is received within the search window of size of [−Expected RSTD Uncertainty×R; +Expected RSTD Uncertainty×R] centred at T_{REF}+1 ms×N+Expected RSTD×4 T_{S}. Expected RSTD Uncertainty (referred to as “nr-DL-PRS-ExpectedRSTD-Uncertainty” in the relevant 3GPP specifications) may have a maximum value of 246×4 T_{S}=32 μs for FR1. T_{REF} (shown in FIG. 4) is the reception time of the beginning of the subframe for the PRS of the assistance data reference TP/TRP at the target device antenna connector, 1 ms×N corresponds to the primary offset 410, Expected RSTD×4 T_{S} corresponds is the secondary offset 420, and T_{S} is the sampling time unit (e.g., for the NR network). Expected RSTD (referred to as “nr-DL-PRS-ExpectedRSTD” in the relevant 3GPP specifications) may have a maximum 3841×4 T_{S}=0.5 ms. The value of integer N can be calculated based on the values for nr-DL-PRS-SFN0-Offset, dl-PRS-Periodicity-and-ResourceSetSlotOffset, and dl-PRS-ResourceSlotOffset (e.g., as defined in relevant 3GPP specifications). Further, the resolution, R, is (a) T_{S} if all PRS resources are in frequency range 2 (FR2), or (b) 4T_{S} otherwise, with T_{S}=1/(15000*2048) seconds.

For TN, a PRS search window may extend 1 ms (from [−0.5 ms, 0.5 ms]) because the uncertainty and RSTD itself is relatively small. However, for NTN positioning (e.g., positioning using non-terrestrial vehicles (e.g., satellites), referred to herein as NTN nodes) in which one or both TPs/TRPs in an RSTD measurement are NTN nodes, the distance between TPs/TRPs may be very large, relative to TN positioning. Because NTN nodes are moving, the uncertainty may be relatively large as well. For example, latency of RF signals received at the UE from an NTN node can range from roughly 5 ms to over 15 ms, depending on where the NTN node is as it moves through the sky (in its orbit) relative to the UE. As such, RSTD values (e.g., RSTD, expected RSTD, RSTD uncertainty) for NTN nodes may far exceed the 1 ms time window used in the existing RSTD framework for TN RSTD measurements.

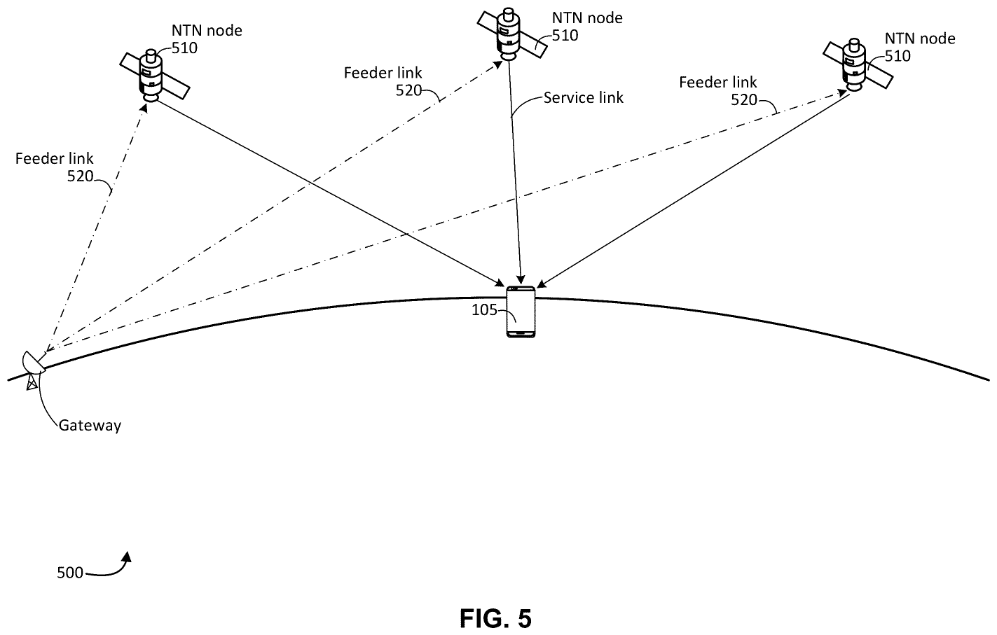

Further, Doppler effects in NTN positioning can result in non-uniform subframe boundaries. In an NTN positioning scenario 500 of FIG. 5, for example, because of high Doppler, the subframes (e.g., between subframes of different NTN nodes 510 and/or between different subframes of the same NTN node) appear to be expanded/contracted at a receiver (e.g., target UE 105). It therefore may be important to define reference point where subframe boundaries are uniform. A reference point can be a base station (e.g., gNB) or NTN nodes 510. When positioning is performed, it can then be done assuming a transmitting TP/TRP is a base station, and compensating feeder link delays (of feeder links 520) and doppler shifts as necessary.

Among other things, NTN positioning may provide network-verified UE location, according to some embodiments. Network verification occurs when the network would like to verify the position of the UE as provided by the UE or another source. For example, the UE may provide the network with a GNSS-based position, but network may want to verify the location (e.g., within a specified or predetermined range) to ensure the location is not erroneous, which may be desirable when services provided to the UE have geographical limitations. An erroneous location of the UE may be provided, for example, if GNSS spoofing of satellite signals is occurring in the location of the UE, or if the UE itself is spoofing its location intentionally.

As noted, techniques for performing positioning of a UE 105 may involve the LMF 220 (e.g., of FIG. 2) providing the UE 105 with assistance data. Such assistance data may be provided in accordance with LPP protocol, and may be provided in different ways, depending on the scenario. FIG. 3 illustrates how assistance data may be provided.

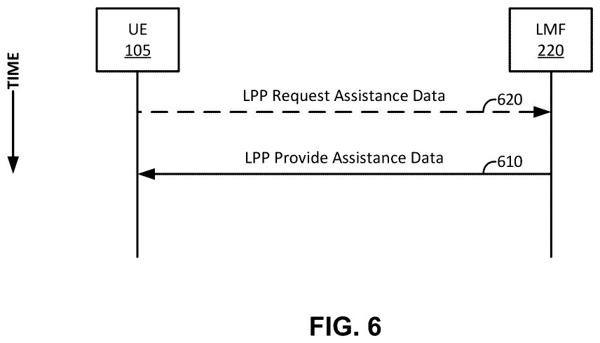

FIG. 6 is a message flow diagram illustrating a basic process of how assistance data may be delivered in a positioning system such as the one illustrated in FIG. 1 and FIG. 2 using LPP, according to some embodiments. The example provided in FIG. 6 illustrates messaging between a UE and LMF for NR positioning system (e.g., as illustrated in FIG. 2), although embodiments are not so limited. Additionally, the exchange in the example illustrated in FIG. 6 is done using LPP protocol, although, again, embodiments are not so limited. Alternative embodiments may be performed in different types of positioning systems and/or may use different protocols.

Assistance data may be exchanged in either UE-based or UE-assisted positioning. In UE-assisted positioning, the LMF 220 may determine that assistance data needs to be provided to the UE 105 (e.g., as part of a positioning procedure) and may send an LPP Provide Assistance Data message to the UE 105, as illustrated by arrow 610 in FIG. 6. On the other hand, in UE-based positioning, the UE may determine that certain positioning assistance data are desired (e.g., as part of a positioning procedure when the LMF provided assistance data are not sufficient for the UE to fulfil the request). In such instances, the UE 105 may send an LPP Request Assistance Data message to the LMF 220, as indicated by arrow 620 (where the dashed line illustrates optional functionality). The LMF 220 may then respond by providing the requested assistance in an LPP Provide Assistance Data message (shown by arrow 610), if available at the LMF 220. Additional details regarding LPP positioning and NG-RAN positioning architecture are provided in 3GPP technical specifications (TS) 38.305 (e.g., sections 5 and 6) and 37.355 (e.g., section 4). Error handling procedures in LPP are discussed in section 5.4 of TS 37.355.

In view of the current limitations and shortcomings of network positioning with respect to the various NTN considerations described above, embodiments herein provide for enhancements to RSTD to enable RSTD measurements and reporting for NTN positioning. In particular, embodiments may address the previously described issues with RSTD measurements in NTN positioning (and/or other issues) in at least two use cases: network verification of UE location and NTN positioning of the UE. To do so, embodiments may (1) use a new, modified RSTD definition, (2) fix Expected RSTD and RSTD uncertainties, (3) use additional signaling related to RSTD, (4) use modified reporting by the UE for RSTD, or a combination thereof. These different aspects are discussed hereafter.

According to some embodiments, a modified RSTD definition that accommodates NTN positioning can build on the traditional definition for RSTD. As previously discussed with respect to FIGS. 3 and 4, the traditional definition for RSTD (e.g., 330 of FIG. 3) extends from [−0.5,0.5] ms. Thus if true RSTD for NTN positioning is 0.6 ms (exceeding the legacy [−0.5,0.5] ms window), measured RSTD will be incorrectly reported by the UE as −0.4 ms as per the legacy RSTD definition. Depending on desired functionality, this issue may be addressed using different options.

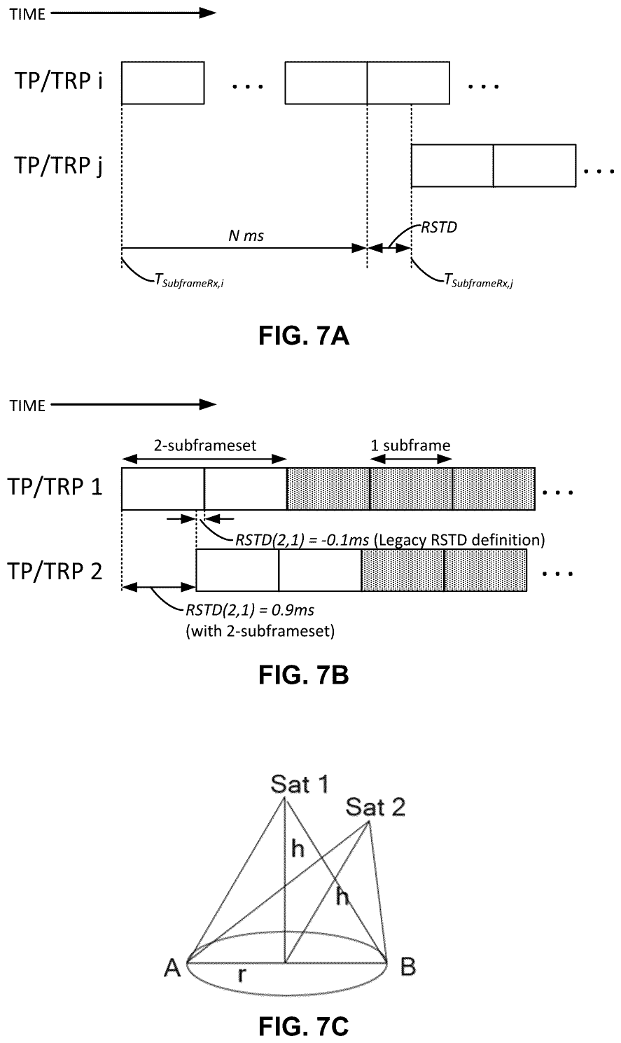

According to a first option, illustrated in FIG. 7A, RSTD may be defined in a manner similar to Expected RSTD. That is, RSTD of neighboring TP/TRP j with respect to reference TP/TRP i may be defined as a time difference between the start of subframe of TP/TRP j containing PRS and T_{SubframeRx,i}+N ms, which is the starting time to which Expected RSTD may be added to get the center of PRS search window for TP/TRP j. (According to some embodiments, N may be configured by a location server (e.g., LMF).) The search window may then be computed as:

$$RSTD ( j , i ) = {T}_{SubframeRx , j} - ( {T}_{SubframeRx , i} + N ms ) , \qquad ( Eqn . l )$$

where N is calculate based on Expected RSTD, SFN offset, PRS periodicity and resource-set slot offset, PRS resource slot offset of TP/TRP i and j.

According to a second option, the notion in the legacy definition of RSTD of using the nearest subframe may be replaced with N-subframeSet, where N is a multiplier that can be configured by a location server.

$$RSTD ( j , i ) = {T}_{N - SubframeSet , Rx , j} - {T}_{N - SubframeRxSet , i} , \qquad ( Eqn . 2 )$$

where T_{N-SubframeSet,Rx,j} is the time when the UE receives the start of one N-subframe-set from TP/TRP j, and T_{N-SubframeSet,Rx,i} is the time when the UE receives the corresponding start of one N-subframeSet from TP/TRP i that is closest in time to the N-SubframeSet received from TP/TRP j.

FIG. 7B is an example of the second option in which an RSTD is determined between TP/TRP 1 and TP/TRP 2. As illustrated, using the legacy RSTD definition would result in an RSTD measurement of −0.1 ms that does not capture the full difference between transmissions. However, using a 2-subframeset (e.g., N=2), the resulting RSTD measurement accurately reflects the 0.9 ms difference.

Thus, the value of N could provide flexibility to accommodate TN and NTN positioning. In the instance where N=1, for example, RSTD would occur within the legacy [−0.5,0.5] ms window. Larger values of N would increase this window to accommodate NTN positioning. For example, if N=2 the RSTD window would increase to [−1,1], if N=3 the RSTD window would increase to [−1.5,1.5], and so forth.

Definitions for Expected RSTD and Expected RSTD Uncertainty could also be modified for NTN positioning, according to some embodiments. As previously noted, NTN positioning may require larger ranges of Expected RSTD and Expected RSTD Uncertainty. Expected RSTD can be in order of several ms rather than 1 ms or less, and Expected RSTD uncertainty can be up to 1-2 ms depending on beam width and satellite altitude. With this in mind, embodiments may utilize modified Expected RSTD and/or Expected RSTD Uncertainty definitions, for example, in accordance with different options.

A first option that may be used comprises explicit signaling. In this case, a larger number of bits may be used to accommodate a larger range. That is, in legacy RSTD reporting by UE, LPP fields corresponding to Expected RSTD and Expected RSTD Uncertainty each have a limited number of bits to represent time values using integers within ranges. In such legacy reporting, integer values for Expected RSTD range from −3841 to 3841, and integer values for Expected RSTD Uncertainty range from 0 to 246. Thus, according to some embodiments implementing this first option, these fields may be allocated additional bits to accommodate larger ranges corresponding to NTN positioning. For example, according to some embodiments, Expected RSTD may be allocated X additional bits, and Expected RSTD Uncertainty may be allocated Y additional bits. Alternative embodiments may use a different number of additional bits, depending on desired functionality.

FIG. 7C is a diagram provided as an example of how an additional bit allocation and expected RSTD uncertainty may be determined geometrically. In this example, if a difference between two LEO satellites (Sat 1 and Sat 2) is 100 km, then 12 additional 12 bits may be needed. Further, if beam diameter (from point A to point B) is 50 km, with Sat 1 at 90° and Sat 2 at 70°, with height 700 km, then the RSTD(2,1) uncertainty at point A could be determined as 708.93−700.44=8.49 km. Similarly, RSTD(2,1) uncertainty value at point B could be determined as 691.84−700.44=−8.89 km, making total uncertainty approximately 17 km. To encode an Expected RSTD Uncertainty value of 17 km, 13 bits may be used.

A second option that may be used also comprises explicit signaling. In this case, new fields may be introduced corresponding to expected RSTD rounded to the number of subframes and expected RSTD uncertainty rounded to the current range, which may be signaled in assistance data. This can be used in addition to expected RSTD and expected RSTD uncertainty (e.g., having legacy integer ranges) to accommodate larger values for expected RSTD and expected RSTD uncertainty in NTN positioning. The number of bits in these additional fields may correspond to the number of additional bits provided in the example above for the first option.

A third option that may be used comprises implicit signaling. In this option, the resolution, R, of expected RSTD uncertainty for NTN positioning may be increased. As previously indicated, R is a resolution applied to expected RSTD uncertainty to define a PRS search window that may have different values in different circumstances: R=T_{S} (for FR2), 4 T_{S} (otherwise). Thus, according to some embodiments, R may be assigned yet another value for NTN positioning. According to some embodiments, R may be an integer multiple of T_{S}. For example, R=kT_{S}, where k=1, 2, 3 . . . .

According to some embodiments, additional parameters may be used in assistance data provided to the UE by the location server for NTN positioning, according to some embodiments. For example, the location server (LMF) may provide assistance data comprising values such as “Expected RSTD Drift,” “Expected RSTD Drift Rate,” “Validity Duration,” or a combination thereof, which (as their names indicate) may reflect drift in RSTD values based on signals from a NG-RAN node (e.g., NTN satellite) due to movement of the NG-RAN node, as well as a time which the validity of these parameters expires (e.g., duration or end time). These parameters may be known by the NG-RAN node, which may provide the parameters to the location server. In such instances, the UE may assume a second order dynamics of Expected RSTD parameterized by drift and drift rate. The Validity Duration may be the maximum time up to which the UE can propagate the Expected RSTD using the second order dynamics without significant deviation (e.g., beyond a threshold amount, which may be dependent on accuracy requirements) from the current value of Expected RSTD, which may be much larger than positioning subframes (e.g., on the order of seconds). After the Validity Duration expires, the UE may request assistance data with new values for Expected RSTD Drift, Expected RSTD Drift Rate, Validity Duration, or a combination thereof.

Depending on desired functionality, embodiments may use different ways of informing the location server about the expiry of the Expected RSTD related parameters. For example, according to a first option, the UE can send an assistance data request to the location server. According to a second option, the UE can send an error message. For instance, new error cause can be added, such as “Expected RSTD Validity Expired” in Target Device Error Causes (as defined in the relevant 3GPP specification(s)). This may prompt the location server to provide updated values in view of error handling in LPP, as described in section 5.4 of the 3GPP specification TS 37.355. To implement this option, a corresponding new clause may be added in Target Device Error Causes for error handling. Thus, responsive to the assistance data request and/or error message provided by the UE, the location server can provide new values for the parameters Expected RSTD Drift, Expected RSTD Drift Rate, Validity Duration, or a combination thereof.

As noted, embodiments may include modified reporting of RSTD by the UE for NTN positioning. For legacy RSTD reporting (as defined in 3GPP specification TS 38.133, Section 10.1.23.3), the reporting range for the DL RSTD measurement is defined from −985024T_{C} to 985024T_{C} with the resolution step of 2^{k}×T_{C}, where kmin≤k≤kmax. According to some embodiments, where NTN positioning results in an RSTD having an absolute value of ≥0.5 ms, reporting can be performed by adding an offset, “RSTD Integer” (denoted as N) which indicates the RSTD in integer multiples of 1 ms. Thus, the actual RSTD (in ms)=N+2^{k}×T_{C}. Depending on desired functionality, reporting the value of the offset N (RSTD Integer) may be done in different ways. N may be reported, for example, per every PRS resource and/or per every TRP (to reduce signaling overhead).

Additionally or alternatively, N may be implicitly computed by the location server (LMF). This can be done in cases where the value of Expected RSTD Uncertainty is small (less than +0.5 ms) and/or in cases where values for expected RSTD and expected RSTD uncertainty allow the location server to determine N implicitly. As an example of such implicit determination, if expected RSTD is 1.3 ms and expected RSTD uncertainty is ±0.1 ms, the resulting RSTD window would be [1.2, 1.4] ms. In such instances, the UE can report an RSTD value between [0.2 and 0.4], which is within a legacy RSTD range, and the location server would compute N to be 1 (representing a 1 ms offset, determined in view of values for expected RSTD and expected RSTD uncertainty), and add it to the value of the reported RSTD by the UE.

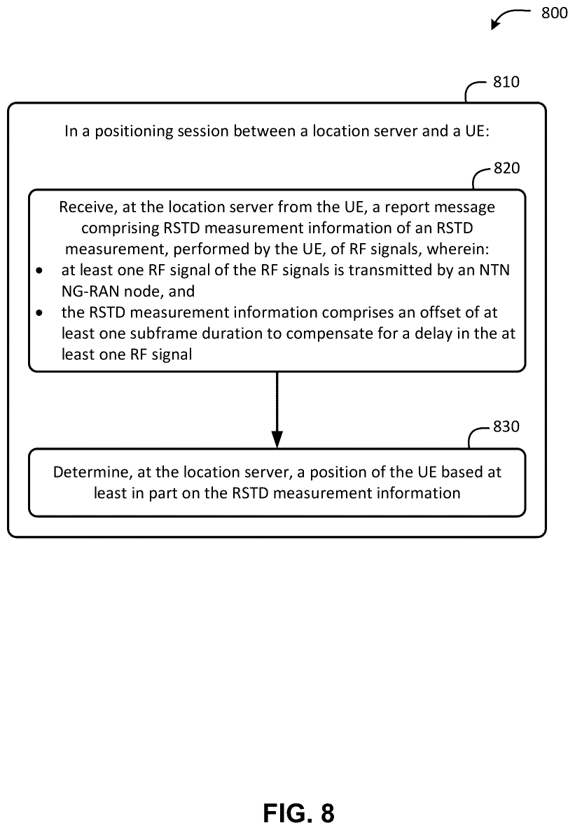

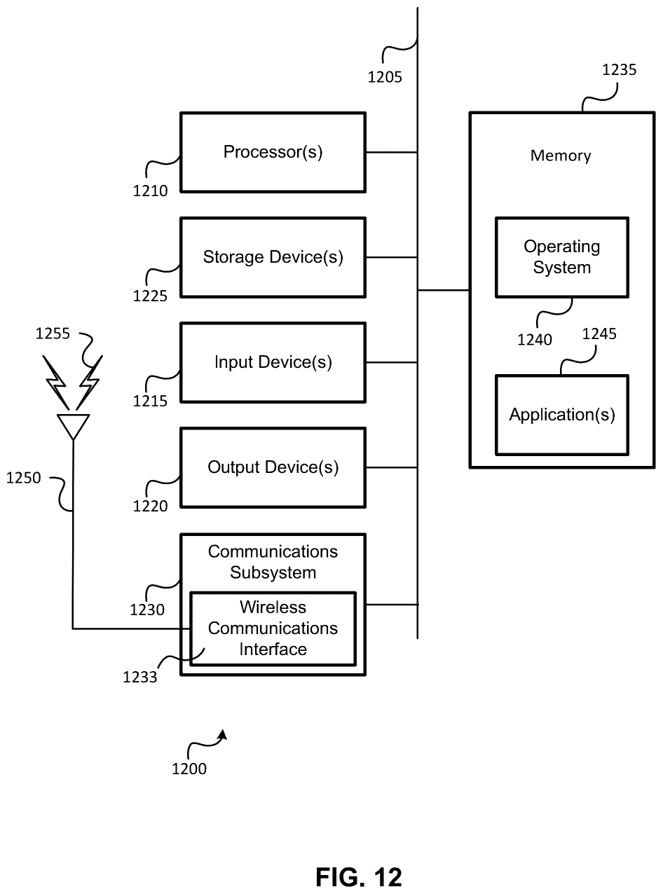

FIG. 8 is a flow diagram of a method 800 utilizing modified RSTD reporting for NTN positioning, according to an embodiment. Structure/means for performing the functionality illustrated in one or more of the blocks shown in FIG. 8 may be performed by hardware and/or software components of a computers system executing and/or operating as a location server (e.g., LMF). Example components of a computer system are illustrated in FIG. 12, which is described in more detail below. As indicated in block 810, the functionality performed at block 820 and block 830 may be performed in a positioning session between the location server and a UE. In some embodiments, this positioning session may comprise an LPP positioning session.

At block 820, the functionality comprises receiving, at the location server from the UE, a report message comprising RSTD measurement information of an RSTD measurement, performed by the UE, of RF signals, wherein: at least one RF signal of the RF signals is transmitted by an NTN NG-RAN node, and the RSTD measurement information comprises an offset of at least one subframe duration to compensate for a delay in the at least one RF signal. As provided in the embodiments herein, the RSTD offset may be provided in any of a variety of ways, depending on desired functionality. According to some embodiments, the asset comprises an integer value in milliseconds, or a subframes the multiplier. In the latter case, the method may further include, prior to receiving the report message at the location server, sending a value of the subframes the multiplier from the location server to the UE. Depending on desired functionality, the offset may be specific to a PRS resource and/or a TRP. According to some embodiments, the offset may be determined by the location server based on values for expected RSTD and expected RSTD uncertainty.

As indicated in the above-described embodiments, the location server may provide assistance data to the UE to help in it can NTN measurements and/or providing NTN reporting. Thus, some embodiments of the method 800 may further comprise, prior to receiving the report message at the location server, sending assistance data from the location server to the UE. In such embodiments, the assistance data may comprise a value for expected RSTD, a value for expected RSTD uncertainty, or both. As described herein, according to some embodiments, the value for the expected RSTD may be provided using at least one or more additional bits or a field indicative of a value corresponding to the expected RSTD rounded to a number of subframes; and the value for the expected RSTD uncertainty is provided using: at least one or more additional bits or a field indicative of a value corresponding to the expected RSTD uncertainty rounded to a current range. Additionally or alternatively, some embodiments may comprise including, in the assistance data, a resolution value for expected RSTD uncertainty, wherein the resolution value is based on a determination that NTN positioning is being performed. As noted herein, the assistance data may be sent in an LPP message, the report message may comprise an LPP message, or both.

As noted above, embodiments may further include data indicative of RSTD drift values. Specifically, some embodiments may comprise including, in the assistance data, expected RSTD drift values and a validity duration of the expected RSTD drift values, wherein the expected RSTD drift values comprise an expected RSTD drift and an expected RSTD drift rate. In such embodiments, sending the assistance data may be responsive to (i) a request for the expected RSTD drift values sent to the location server from the UE, or (ii) an error message sent to the location server from the UE, wherein the error message comprises an indication that a previous validity duration corresponding to previous expected RSTD drift values has expired.

Means for performing functionality at block 820 may comprise a bus 1205, processor(s) 1210, storage device(s) 1225, input device(s) 1215, communications subsystem 1230, memory 1235 (including operating system 1240 and/or application(s) 1245), and/or other components of a computer system 1200, as illustrated in FIG. 12.

At block 830, the functionality comprises determining, at the location server, a position of the UE based at least in part on the RSTD measurement information. In particular, the location server may determine the position of the UE based at least in part on the offset included in the RSTD measurement information account for NTN-related signal delay. Further, the way in which the position of the UE is determined may vary, based on the type of positioning procedure performed (e.g., RTT, TDOA, etc.).

Means for performing functionality at block 830 may comprise a bus 1205, processor(s) 1210, storage device(s) 1225, input device(s) 1215, communications subsystem 1230, memory 1235 (including operating system 1240 and/or application(s) 1245), and/or other components of a computer system 1200, as illustrated in FIG. 12.

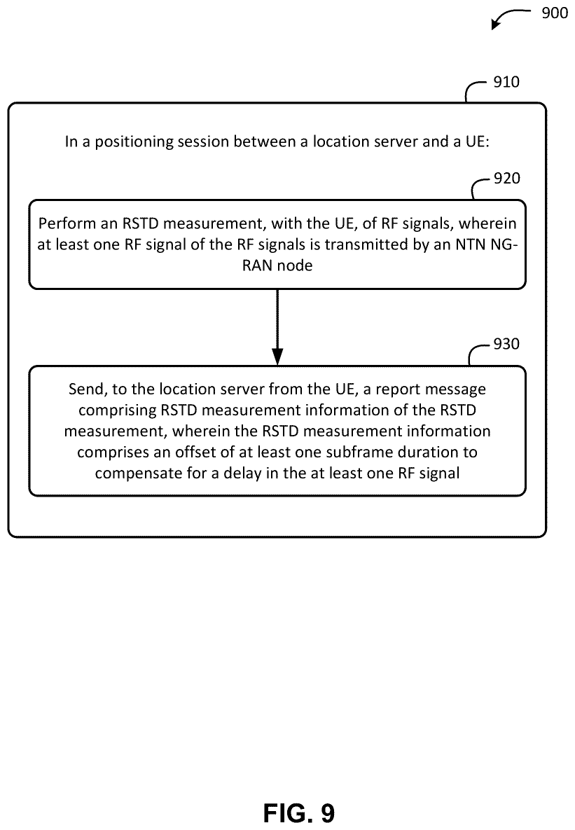

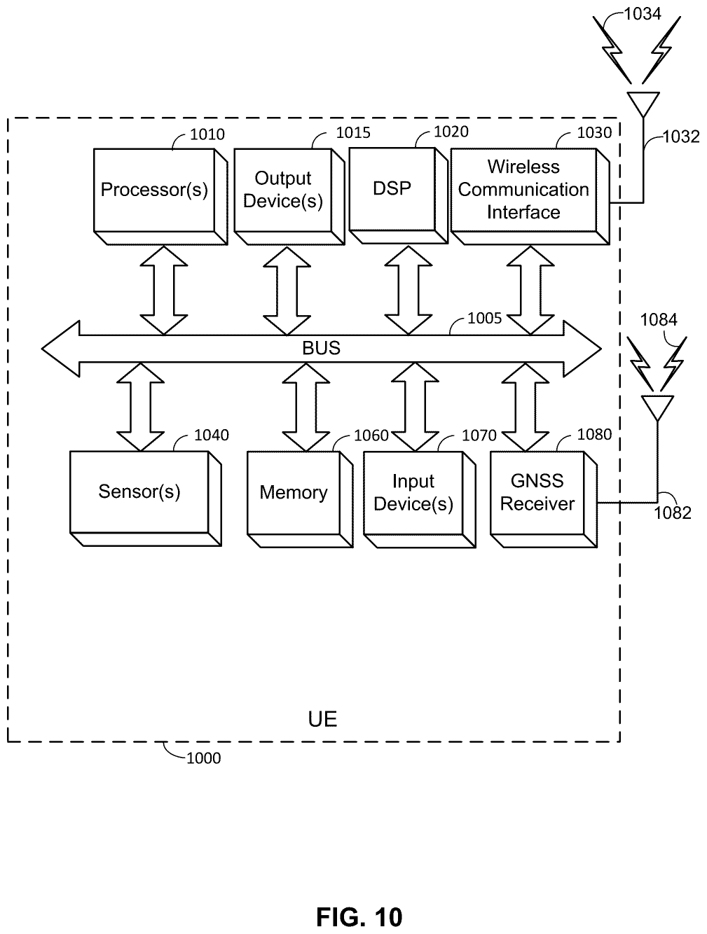

FIG. 9 is a flow diagram of a method 900 of utilizing modified RSTD reporting for NTN positioning, according to an embodiment. Structure/means for performing the functionality illustrated in one or more of the blocks shown in FIG. 9 may be performed by hardware and/or software components of a computers system executing and/or operating as a UE. In some aspects, the functionality in FIG. 9 may reflect UE-side functionality corresponding to the server-side functionality illustrated in FIG. 8. Example components of a UE are illustrated in FIG. 10, which is described in more detail below. As indicated in block 910, the functionality performed at block 920 and block 930 may be performed in a positioning session between the location server and a UE. Again, in some embodiments, this positioning session may comprise an LPP positioning session.

At block 920, the functionality comprises performing an RSTD measurement, with the UE, of RF signals, wherein at least one RF signal of the RF signals is transmitted by an NTN NG-RAN node. As indicated herein, RS signal measurements for positioning may be based on assistance data received by the UE. As such, some embodiments comprise, prior to performing the RSTD measurement, receiving assistance data, at the UE, from the location server.

As noted herein, embodiments may utilize assistance data that has been modified to account for NTN-specific considerations. In some embodiments, the assistance data may comprise a value for expected RSTD and a value for expected RSTD uncertainty. In such embodiments, the value for the expected RSTD may be provided using at least one or more additional bits, or a field indicative of a value corresponding to the expected RSTD rounded to a number of subframes, and the value for the expected RSTD uncertainty is provided using: at least one or more additional bits, or a field indicative of a value corresponding to the expected RSTD uncertainty rounded to a current range. According to some embodiments, the assistance data may comprise a resolution value for expected RSTD uncertainty, wherein the resolution value is based on a determination to that NTN positioning is being performed. In such embodiments, the assistance data may comprise expected RSTD drift values and a validity duration of the expected RSTD drift values, wherein the expected RSTD drift values comprise an expected RSTD drift and an expected RSTD drift rate. Some embodiments may further include, prior to receiving the assistance data, sending: (i) a request for the expected RSTD drift values sent from the UE to the location server. Additionally or alternatively, embodiments may include, prior to receiving the assistance data, sending, or (ii) an error message sent from the UE to the location server, wherein the error message comprises an indication that a previous validity duration corresponding to previous expected RSTD drift values has expired.

Means for performing functionality at block 920 may comprise a bus 1005, processor(s) 1010, digital signal processor (DSP) 1020, wireless communication interface 1030, memory 1060, and/or other components of a UE 1000 as illustrated in FIG. 10.

At block 930, the functionality comprises sending, to the location server from the UE, a report message comprising RSTD measurement information of the RSTD measurement, wherein the RSTD measurement information comprises an offset of at least one subframe duration to compensate for a delay in the at least one RF signal. In some embodiments, the report and/or the assistance data is included in an LPP message. Additionally or alternatively, the offset may be specific to a PRS resource or a TRP. According to some embodiments, the offset may comprise and integer value (e.g., in milliseconds), or a subframes set multiplier. In the latter case, embodiments may further comprise receiving, prior to message, a value of the subframes said multiplier from the location server.

Means for performing functionality at block 930 may comprise a bus 1005, processor(s) 1010, digital signal processor (DSP) 1020, wireless communication interface 1030, memory 1060, and/or other components of a UE 1000 as illustrated in FIG. 10.

FIG. 10 is a block diagram of an embodiment of a UE 1000, which can be utilized as described herein. It should be noted that FIG. 10 is meant only to provide a generalized illustration of various components, any or all of which may be utilized as appropriate. It can be noted that, in some instances, components illustrated by FIG. 10 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 10.

The UE 1000 is shown comprising hardware elements that can be electrically coupled via a bus 1005 (or may otherwise be in communication, as appropriate). The hardware elements may include a processor(s) 1010 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1010 may comprise one or more processing units, which may be housed in a single integrated circuit (IC) or multiple ICs. As shown in FIG. 10, some embodiments may have a separate DSP 1020, depending on desired functionality. Location determination and/or other determinations based on wireless communication may be provided in the processor(s) 1010 and/or wireless communication interface 1030 (discussed below). The UE 1000 also can include one or more input devices 1070, which can include without limitation one or more keyboards, touch screens, touch pads, microphones, buttons, dials, switches, and/or the like; and one or more output devices 1015, which can include without limitation one or more displays (e.g., touch screens), light emitting diodes (LEDs), speakers, and/or the like.

The UE 1000 may also include a wireless communication interface 1030, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 1000 to communicate with other devices as described in the embodiments above. The wireless communication interface 1030 may permit data and signaling to be communicated (e.g., transmitted and received) with NG-RAN nodes of a network, for example, via eNBs, gNBs, ng-eNBs, access points, NTN satellites, various base stations, TRPs, and/or other access node types, and/or other network components, computer systems, and/or any other electronic devices communicatively coupled with TRPs, as described herein. The communication can be carried out via one or more wireless communication antenna(s) 1032 that send and/or receive wireless signals 1034. According to some embodiments, the wireless communication antenna(s) 1032 may comprise a plurality of discrete antennas, antenna arrays, or any combination thereof. The antenna(s) 1032 may be capable of transmitting and receiving wireless signals using beams (e.g., Tx beams and Rx beams). Beam formation may be performed using digital and/or analog beam formation techniques, with respective digital and/or analog circuitry. The wireless communication interface 1030 may include such circuitry.

Depending on desired functionality, the wireless communication interface 1030 may comprise a separate receiver and transmitter, or any combination of transceivers, transmitters, and/or receivers to communicate with base stations (e.g., ng-eNBs and gNBs) and other terrestrial transceivers, such as wireless devices and access points, as well as NTN satellites. The UE 1000 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 1000 can further include sensor(s) 1040. Sensor(s) 1040 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 1000 may also include a Global Navigation Satellite System (GNSS) receiver 1080 capable of receiving signals 1084 from one or more GNSS satellites using an antenna 1082 (which could be the same as antenna 1032). Positioning based on GNSS signal measurement can be utilized to complement and/or incorporate the techniques described herein. The GNSS receiver 1080 can extract a position of the UE 1000, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1080 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1080 is illustrated in FIG. 10 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1010, DSP 1020, and/or a processor within the wireless communication interface 1030 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processors, such as processor(s) 1010 or DSP 1020.

The UE 1000 may further include and/or be in communication with a memory 1060. The memory 1060 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1060 of the UE 1000 also can comprise software elements (not shown in FIG. 10), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1060 that are executable by the UE 1000 (and/or processor(s) 1010 or DSP 1020 within UE 1000). In some embodiments, then, such code and/or instructions can be used to configure and/or adapt a general-purpose computer (or other device) to perform one or more operations in accordance with the described methods.

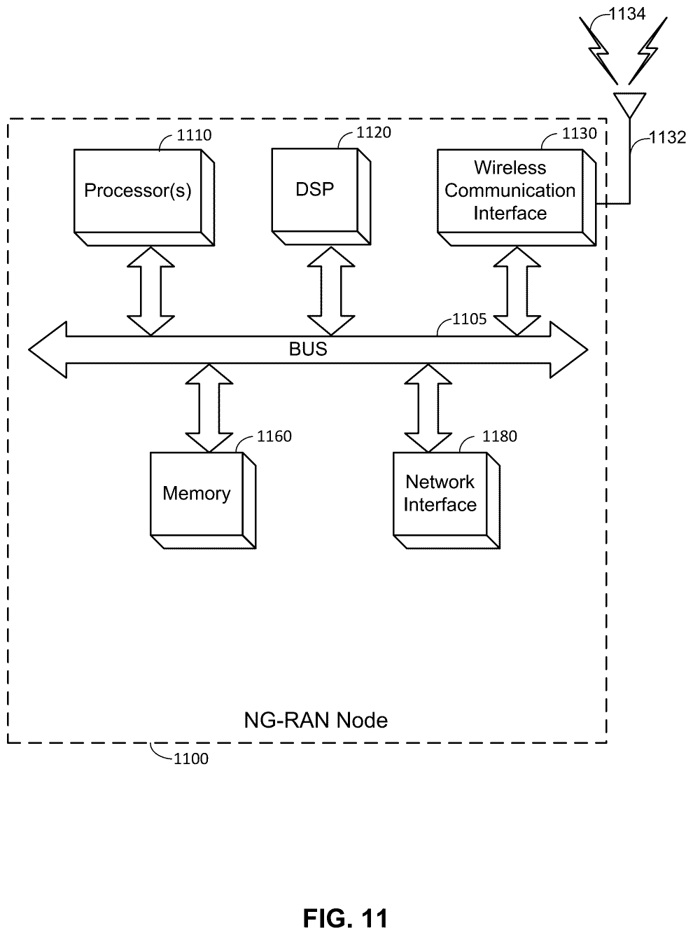

FIG. 11 is a block diagram of an embodiment of a NG-RAN node 1100, which can be utilized as described herein above, in connection with base stations, TRPs, NTN satellites and other such NG-RAN nodes of a wireless network. It should be noted that FIG. 11 is meant only to provide a generalized illustration of various components, any or all of which may be utilized as appropriate. In some embodiments, the NG-RAN node 1100 may correspond to a gNB, an ng-eNB, and/or (more generally) a TRP.

The NG-RAN node 1100 is shown comprising hardware elements that can be electrically coupled via a bus 1105 (or may otherwise be in communication, as appropriate). The hardware elements may include a processor(s) 1110 which can include without limitation one or more general-purpose processors, one or more special-purpose processors (such as DSP chips, graphics acceleration processors, ASICs, and/or the like), and/or other processing structure or means. As shown in FIG. 11, some embodiments may have a separate DSP 1120, depending on desired functionality. Location determination and/or other determinations based on wireless communication may be provided in the processor(s) 1110 and/or wireless communication interface 1130 (discussed below), according to some embodiments. The NG-RAN node 1100 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The NG-RAN node 1100 might also include a wireless communication interface 1130, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the NG-RAN node 1100 to communicate as described herein. The wireless communication interface 1130 may permit data and signaling to be communicated (e.g., transmitted and received) to UEs, other base stations/TRPs (e.g., eNBs, gNBs, and ng-eNBs), and/or other network components, computer systems, and/or any other electronic devices described herein. The communication can be carried out via one or more wireless communication antenna(s) 1132 that send and/or receive wireless signals 1134.

The NG-RAN node 1100 may also include a network interface 1180, which can include support of wireline communication technologies for a terrestrial NG-RAN node. For non-terrestrial NG-RAN nodes (e.g., NTN satellites, NTN aerial vehicles, etc.) the network interface 1180 may comprise a satellite and/or wireless interface. The network interface 1180 may include a modem, network card, chipset, and/or the like. The network interface 1180 may include one or more input and/or output communication interfaces to permit data to be exchanged with a network, communication network servers, computer systems, and/or any other electronic devices described herein.

In many embodiments, the NG-RAN node 1100 may further comprise a memory 1160. The memory 1160 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 1160 of the NG-RAN node 1100 also may comprise software elements (not shown in FIG. 11), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1160 that are executable by the NG-RAN node 1100 (and/or processor(s) 1110 or DSP 1120 within NG-RAN node 1100). In some embodiments, then, such code and/or instructions can be used to configure and/or adapt a general-purpose computer (or other device) to perform one or more operations in accordance with the described methods.

FIG. 12 is a block diagram of an embodiment of a computer system 1200, which may be used, in whole or in part, to provide the functions of one or more network components as described in the embodiments herein (e.g., location server 160 of FIG. 1, LMF 220 of FIG. 2, and/or the like). It should be noted that FIG. 12 is meant only to provide a generalized illustration of various components, any or all of which may be utilized as appropriate. FIG. 12, therefore, broadly illustrates how individual system elements may be implemented in a relatively separated or relatively more integrated manner. In addition, it can be noted that components illustrated by FIG. 12 can be localized to a single device and/or distributed among various networked devices, which may be disposed at different geographical locations.

The computer system 1200 is shown comprising hardware elements that can be electrically coupled via a bus 1205 (or may otherwise be in communication, as appropriate). The hardware elements may include processor(s) 1210, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1200 also may comprise one or more input devices 1215, which may comprise without limitation a mouse, a keyboard, a camera, a microphone, and/or the like; and one or more output devices 1220, which may comprise without limitation a display device, a printer, and/or the like.

The computer system 1200 may further include (and/or be in communication with) one or more non-transitory storage devices 1225, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1200 may also include a communications subsystem 1230, which may comprise wireless communication technologies managed and controlled by a wireless communication interface 1233, as well as wired technologies (such as Ethernet, coaxial communications, universal serial bus (USB), and the like). The wireless communication interface 1233 may comprise one or more wireless transceivers that may send and receive wireless signals 1255 (e.g., signals according to 5G NR or LTE) via wireless antenna(s) 1250. Thus the communications subsystem 1230 may comprise a modem, a network card (wireless or wired), an infrared communication device, a wireless communication device, and/or a chipset, and/or the like, which may enable the computer system 1200 to communicate on any or all of the communication networks described herein to any device on the respective network, including a User Equipment (UE), base stations and/or other TRPs, and/or any other electronic devices described herein. Hence, the communications subsystem 1230 may be used to receive and send data as described in the embodiments herein.

In many embodiments, the computer system 1200 will further comprise a working memory 1235, which may comprise a RAM or ROM device, as described above. Software elements, shown as being located within the working memory 1235, may comprise an operating system 1240, device drivers, executable libraries, and/or other code, such as one or more applications 1245, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1225 described above. In some cases, the storage medium might be incorporated within a computer system, such as computer system 1200. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1200 and/or might take the form of source and/or installable code, which, upon compilation and/or installation on the computer system 1200 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. A method of utilizing modified Reference Signal Time Difference (RSTD) reporting for Non-Terrestrial Network (NTN) positioning, the method comprising: in a positioning session between a location server and a user equipment (UE): receiving, at the location server from the UE, a report message comprising RSTD measurement information of an RSTD measurement, performed by the UE, of radio frequency (RF) signals, wherein: at least one RF signal of the RF signals is transmitted by an NTN Next Generation Radio Access Network (NG-RAN) node, and the RSTD measurement information comprises an offset of at least one subframe duration to compensate for a delay in the at least one RF signal; and determining, at the location server, a position of the UE based at least in part on the RSTD measurement information.

Clause 2. The method of clause 1, wherein the offset comprises an integer value in milliseconds.

Clause 3. The method of clause 1 wherein the offset comprises an subframe set multiplier.

Clause 4. The method of clause 3 further comprising, prior to receiving the report message at the location server, sending a value of the subframe set multiplier from the location server to the UE.

Clause 5. The method of any of clauses 1-4 further comprising, prior to receiving the report message at the location server, sending assistance data from the location server to the UE.

Clause 6. The method of clause 5 wherein the assistance data comprises a value for expected RSTD and a value for expected RSTD uncertainty.

Clause 7. The method of clause 6 wherein the value for the expected RSTD is provided using at least one or more additional bits; and the value for the expected RSTD uncertainty is provided using at least one or more additional bits.

Clause 8. The method of any of clauses 6-7 further comprising a field indicative of a value corresponding to the expected RSTD rounded to a number of subframes; and a field indicative of a value corresponding to the expected RSTD uncertainty rounded to a current range.

Clause 9. The method of any of clauses 6-8 further comprising including, in the assistance data, a resolution value for expected RSTD uncertainty, wherein the resolution value is based on a determination that NTN positioning is being performed.

Clause 10. The method of any of clauses 5-9 wherein the assistance data comprises expected RSTD drift values and a validity duration of the expected RSTD drift values, wherein the expected RSTD drift values comprise an expected RSTD drift and an expected RSTD drift rate.

Clause 11. The method of clause 10 wherein sending the assistance data is responsive to a request for the expected RSTD drift values sent to the location server from the UE.

Clause 12. The method of any of clauses 10-11 wherein sending the assistance data is responsive to an error message sent to the location server from the UE, wherein the error message comprises an indication that a previous validity duration corresponding to previous expected RSTD drift values has expired.

Clause 13. The method of any of clauses 5-12 wherein the assistance data is sent in an LTE Positioning Protocol (LPP) message.

Clause 14. The method of any of clauses 1-13 wherein the offset is specific to a positioning reference signal (PRS) resource.

Clause 15. The method of any of clauses 1-13 wherein the offset is specific to a Transmission Reception Point (TRP).

Clause 16. The method of any of clauses 1-15 wherein the offset is determined by the location server based on values for expected RSTD and Expected RSTD uncertainty.

Clause 17. The method of any of clauses 1-16 wherein the report message comprises a LPP message.

Clause 18. The method of any of clauses 1-17 wherein the location server comprises a location management function (LMF) of a fifth generation (5G) New Radio (NR) communication network.

Clause 19. A device comprising: a transceiver; a memory; and one or more processors communicatively coupled with the transceiver and the memory, and wherein the one or more processors are configured to perform the method of any of claims 1-18.

Clause 20. A device comprising means for performing the method of any of claims 1-18.

Clause 21. A non-transitory computer-readable medium having instructions embedded thereon, which, when executed by one or more processors, cause the one or more processors to perform the method of any of claims 1-18.

Clause 22. A method of utilizing modified Reference Signal Time Difference (RSTD) reporting for Non-Terrestrial Network (NTN) positioning, the method comprising: in a positioning session between a location server and a user equipment (UE): performing an RSTD measurement, with the UE, of radio frequency (RF) signals, wherein at least one RF signal of the RF signals is transmitted by an NTN Next Generation Radio Access Network (NG-RAN) node; and sending, to the location server from the UE, a report message comprising RSTD measurement information of the RSTD measurement, wherein the RSTD measurement information comprises an offset of at least one subframe duration to compensate for a delay in the at least one RF signal.

Clause 23. The method of clause 22, wherein the offset comprises an integer value in milliseconds.

Clause 24. The method of clause 22 wherein the offset comprises an subframe set multiplier.

Clause 25. The method of clause 24 further comprising, prior to sending the report message, receiving, at the UE, a value of the subframe set multiplier from the location server.

Clause 26. The method of any of clauses 22-25 further comprising, prior to sending the report message, receiving assistance data, at the UE, from the location server.

Clause 27. The method of clause 26 wherein the assistance data comprises a value for expected RSTD and a value for expected RSTD uncertainty.

Clause 28. The method of clause 27 wherein the value for the expected RSTD is provided using at least one or more additional bits; and the value for the expected RSTD uncertainty is provided using at least one or more additional bits.

Clause 29. The method of any of clauses 27-28 further comprising a field indicative of a value corresponding to the expected RSTD rounded to a number of subframes; and a field indicative of a value corresponding to the expected RSTD uncertainty rounded to a current range.

Clause 30. The method of any of clauses 27-29 further comprising including, in the assistance data, a resolution value for expected RSTD uncertainty, wherein the resolution value is based on a determination to that NTN positioning is being performed.

Clause 31. The method of any of clauses 26-30 wherein the assistance data comprises expected RSTD drift values and a validity duration of the expected RSTD drift values, wherein the expected RSTD drift values comprise an expected RSTD drift and an expected RSTD drift rate.

Clause 32. The method of clause 31 further comprising, prior to receiving the assistance data, sending a request for the expected RSTD drift values sent from the UE to the location server.

Clause 33. The method of any of clauses 31-32 further comprising, prior to receiving the assistance data, sending an error message sent from the UE to the location server, wherein the error message comprises an indication that a previous validity duration corresponding to previous expected RSTD drift values has expired.

Clause 34. The method of any of clauses 26-33 wherein the assistance data is included in an LTE Positioning Protocol (LPP) message.

Clause 35. The method of any of clauses 22-34 wherein the offset is specific to a positioning reference signal (PRS) resource.

Clause 36. The method of any of clauses 22-34 wherein the offset is specific to a Transmission Reception Point (TRP).

Clause 37. The method of any of clauses 22-36 wherein the offset is determined by the location server based on values for expected RSTD and Expected RSTD uncertainty.

Clause 38. The method of any of clauses 22-37 wherein the report message comprises a LPP message.

Clause 39. The method of any of clauses 22-38 wherein the location server comprises a location management function (LMF) of a fifth generation (5G) New Radio (NR) communication network.

Clause 40. A device comprising: a transceiver; a memory; and one or more processors communicatively coupled with the transceiver and the memory, and wherein the one or more processors are configured to perform the method of any of claims 22-39.

Clause 41. A device comprising means for performing the method of any of claims 22-39.

Clause 42. A non-transitory computer-readable medium having instructions embedded thereon, which, when executed by one or more processors, cause the one or more processors to perform the method of any of claims 22-39.

What is claimed is:

1. A method of utilizing modified Reference Signal Time Difference (RSTD) reporting for Non-Terrestrial Network (NTN) positioning, the method comprising:
in a positioning session between a location server and a user equipment (UE):
receiving, at the location server from the UE, a report message comprising RSTD measurement information of an RSTD measurement, performed by the UE, of radio frequency (RF) signals, wherein:
at least one RF signal of the RF signals is transmitted by an NTN Next Generation Radio Access Network (NG-RAN) node, and
the RSTD measurement information comprises an offset of at least one subframe duration to compensate for a delay in the at least one RF signal; and
determining, at the location server, a position of the UE based at least in part on the RSTD measurement information.

2. The method of claim 1, wherein the offset comprises an integer value in milliseconds or a subframe set multiplier.

3. The method of claim 1, further comprising, prior to receiving the report message at the location server, sending assistance data from the location server to the UE.

4. The method of claim 3, wherein the assistance data comprises a value for expected RSTD and a value for expected RSTD uncertainty.

5. The method of claim 4, wherein:
the value for the expected RSTD is provided using:
at least one or more additional bits, or
a field indicative of a value corresponding to the expected RSTD rounded to a number of subframes; and
the value for the expected RSTD uncertainty is provided using:
at least one or more additional bits, or
a field indicative of a value corresponding to the expected RSTD uncertainty rounded to a current range.

6. The method of claim 4, further comprising including, in the assistance data, a resolution value for expected RSTD uncertainty, wherein the resolution value is based on a determination that NTN positioning is being performed.

7. The method of claim 3, further comprising including, in the assistance data, expected RSTD drift values and a validity duration of the expected RSTD drift values, wherein the expected RSTD drift values comprise an expected RSTD drift and an expected RSTD drift rate.

8. The method of claim 7, wherein sending the assistance data is responsive to: (i) a request for the expected RSTD drift values sent to the location server from the UE, or (ii) an error message sent to the location server from the UE, wherein the error message comprises an indication that a previous validity duration corresponding to previous expected RSTD drift values has expired.

9. The method of claim 1, wherein the offset is specific to a positioning reference signal (PRS) resource or a Transmission Reception Point (TRP).

10. The method of claim 1, wherein the offset is determined by the location server based on values for expected RSTD and expected RSTD uncertainty.

11. A method of utilizing modified Reference Signal Time Difference (RSTD) reporting for Non-Terrestrial Network (NTN) positioning, the method comprising:
in a positioning session between a location server and a user equipment (UE):
performing an RSTD measurement, with the UE, of radio frequency (RF) signals, wherein at least one RF signal of the RF signals is transmitted by an NTN Next Generation Radio Access Network (NG-RAN) node; and
sending, to the location server from the UE, a report message comprising RSTD measurement information of the RSTD measurement, wherein the RSTD measurement information comprises an offset of at least one subframe duration to compensate for a delay in the at least one RF signal.

12. The method of claim 11, wherein the offset comprises an integer value in milliseconds or a subframe set multiplier.

13. The method of claim 11, further comprising, prior to performing an RSTD measurement, receiving assistance data, at the UE, from the location server.

14. The method of claim 13, wherein the assistance data comprises a value for expected RSTD and a value for expected RSTD uncertainty.

15. The method of claim 14, wherein:
the value for the expected RSTD is provided using:
at least one or more additional bits, or
a field indicative of a value corresponding to the expected RSTD rounded to a number of subframes; and
the value for the expected RSTD uncertainty is provided using:
at least one or more additional bits, or
a field indicative of a value corresponding to the expected RSTD uncertainty rounded to a current range.

16. The method of claim 14, wherein the assistance data comprises a resolution value for expected RSTD uncertainty, wherein the resolution value is based on a determination to that NTN positioning is being performed.

17. The method of claim 13, wherein the assistance data comprises expected RSTD drift values and a validity duration of the expected RSTD drift values, wherein the expected RSTD drift values comprise an expected RSTD drift and an expected RSTD drift rate.

18. The method of claim 17, further comprising, prior to receiving the assistance data, sending: (i) a request for the expected RSTD drift values sent from the UE to the location server, or (ii) an error message sent from the UE to the location server, wherein the error message comprises an indication that a previous validity duration corresponding to previous expected RSTD drift values has expired.

19. The method of claim 11, wherein the offset is specific to a positioning reference signal (PRS) resource or a Transmission Reception Point (TRP).

20. A location server for utilizing modified Reference Signal Time Difference (RSTD) reporting for Non-Terrestrial Network (NTN) positioning, the location server comprising:
a transceiver;
a memory; and
one or more processors communicatively coupled with the transceiver and the memory, wherein the one or more processors are configured to:
in a positioning session between the location server and a user equipment (UE):
receive, via the transceiver from the UE, a report message comprising RSTD measurement information of an RSTD measurement, performed by the UE, of radio frequency (RF) signals, wherein:
at least one RF signal of the RF signals is transmitted by an NTN Next Generation Radio Access Network (NG-RAN) node, and
the RSTD measurement information comprises an offset of at least one subframe duration to compensate for a delay in the at least one RF signal; and
determine a position of the UE based at least in part on the RSTD measurement information.

21. The location server of claim 20, wherein the offset comprises an integer value in milliseconds or a subframe set multiplier.

22. The location server of claim 20, wherein the one or more processors are further configured to, prior to receiving the report message at the location server, send assistance data via the transceiver to the UE.

23. The location server of claim 22, wherein the one or more processors are further configured to include, in the assistance data, a value for expected RSTD and a value for expected RSTD uncertainty.

24. The location server of claim 23, wherein:
the value for the expected RSTD is provided using:
at least one or more additional bits, or
a field indicative of a value corresponding to the expected RSTD rounded to a number of subframes; and
the value for the expected RSTD uncertainty is provided using:
at least one or more additional bits, or
a field indicative of a value corresponding to the expected RSTD uncertainty rounded to a current range.

25. The location server of claim 23, wherein the one or more processors are further configured to include, in the assistance data, a resolution value for expected RSTD uncertainty, wherein the resolution value is based on a determination that NTN positioning is being performed.

26. The location server of claim 22, wherein the one or more processors are further configured to include, in the assistance data, expected RSTD drift values and a validity duration of the expected RSTD drift values, wherein the expected RSTD drift values comprise an expected RSTD drift and an expected RSTD drift rate.

27. The location server of claim 26, wherein the one or more processors are configured to send the assistance data is responsive to: (i) a request for the expected RSTD drift values sent to the location server from the UE, or (ii) an error message sent to the location server from the UE, wherein the error message comprises an indication that a previous validity duration corresponding to previous expected RSTD drift values has expired.

28. A user equipment (UE) for utilizing modified Reference Signal Time Difference (RSTD) reporting for Non-Terrestrial Network (NTN) positioning, the UE comprising:
a transceiver;
a memory; and
one or more processors communicatively coupled with the transceiver and the memory, wherein the one or more processors are configured to:
in a positioning session between a location server and the UE:
perform an RSTD measurement of radio frequency (RF) signals, wherein at least one RF signal of the RF signals is transmitted by an NTN Next Generation Radio Access Network (NG-RAN) node; and
send, via the transceiver to the location server, a report message comprising RSTD measurement information of the RSTD measurement, wherein the RSTD measurement information comprises an offset of at least one subframe duration to compensate for a delay in the at least one RF signal.

29. The UE of claim 28, wherein the offset comprises an integer value in milliseconds or a subframe set multiplier.

30. The UE of claim 28, wherein the one or more processors are further configured to, prior to performing an RSTD measurement, receive assistance data, at the UE, from the location server.
